(19) United States
(12) Patent Application Publication
(10) Pub. No.: US 2019/0313604 A1
(43) Pub. Date: Oct. 17, 2019

(54) COLLAPSIBLE GRAVITY PET FEEDER

(71) Applicant: Loving Pets Corporation, Cranbury Township, NJ (US)

(72) Inventors: John James Stone, Golden, CO (US); Amy Elizabeth Stone, Golden, CO (US)

(21) Appl. No.: 15/955,071

(22) Filed: Apr. 17, 2018

(51) Int. Cl. A01K 5/02; A01K 7/02

(52) U.S. Cl. CPC A01K 5/0225; A01K 7/02

(57) ABSTRACT

A collapsible pet feeder apparatus for holding pet food or water, comprised of a collapsible storage compartment adapted to be expanded to an elongated state for storing pet food or water, a bowl portion positioned underneath the opening in the bottom portion of the collapsible storage compartment for holding pet food or water and wherein the bowl portion extends away from a side of the collapsible storage compartment, an angled slide portion positioned underneath the opening in the bottom portion of the collapsible storage compartment for facilitating the movement of pet food or water from the collapsible storage compartment to a distal end of the bowl portion. In operation, gravity provides force to move the food or water from the storage compartment into the bowl, when the bowl is not full.

### BACKGROUND OF THE INVENTIVE FIELD

The present invention is directed to the field of pet feeding devices. More particularly, the present invention relates to a collapsible gravity pet feeder adapted to be locked for easy storage and transport.

### SUMMARY OF THE GENERAL INVENTIVE CONCEPT

The present invention is directed to a collapsible feeding apparatus or bowl for pets, more particularly to a collapsible feeding apparatus having an angled slide portion for facilitating the movement of pet food or water from a collapsible storage compartment to a distal end of a bowl portion of the feed apparatus.

Although collapsible feeding bowls are known in the art, the present invention is novel in that it provides a unique combination of features that provides a portable feeding/drinking apparatus having a collapsible and expandable storage compartment positioned with a bowl portion having an angled slide portion to allow the movement of food or water from the collapsible storage compartment to a distal end of the bowl portion.

The foregoing and other features and advantages of the present invention will be apparent from the following more detailed description of the particular embodiments, as illustrated in the accompanying drawings.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates a perspective view of one exemplary embodiment of a collapsible pet feeder of the present invention;

FIG. 2 illustrates an exploded view of the collapsible pet feeder of FIG. 1;

FIG, 3 illustrates a cross-section side view of the collapsible pet feeder of FIG. 1;

FIG. 4 illustrates an exploded view of a water version of the collapsible pet feeder of the present invention;

FIG. 5 illustrates a cross-section side view of the water version of the collapsible pet feeder of the present invention;

FIG. 6A illustrates a close-up view of the latch portion of the present invention;

FIG. 6B illustrates a close-up view of FIG. 6A;

FIG. 7 a top view of the water version of the collapsible pet feeder of the present invention with the collapsible storage compartment removed;

FIG. 8 illustrates one embodiment of the collapsible storage compartment with a water cap;

FIG. 9 illustrates one embodiment of the adapter portion of the present invention;

FIG. 10 illustrates one embodiment of the bottom portion of the collapsible storage compartment of the present invention;

FIG. 11 illustrates a side view of the water version of the collapsible pet feeder of the present invention with the collapsible storage container in an expanded state;

FIG. 12 illustrates a side view of the water version of the collapsible pet feeder of the present invention with the collapsible storage container in a collapsed state;

FIG. 13 illustrates one embodiment of the bottom of a distal portion of the bowl of the present invention.

### DETAILED DESCRIPTION OF EXEMPLARY EMBODIMENT(S)

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

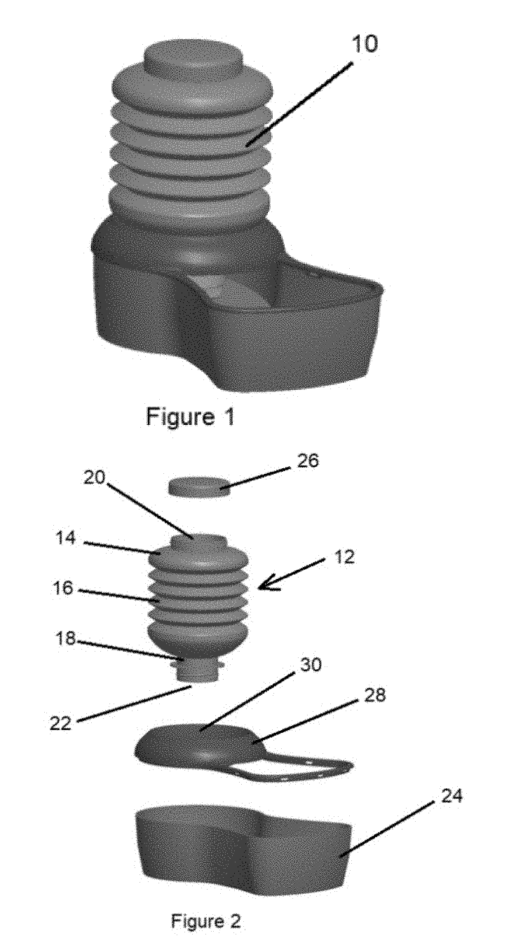

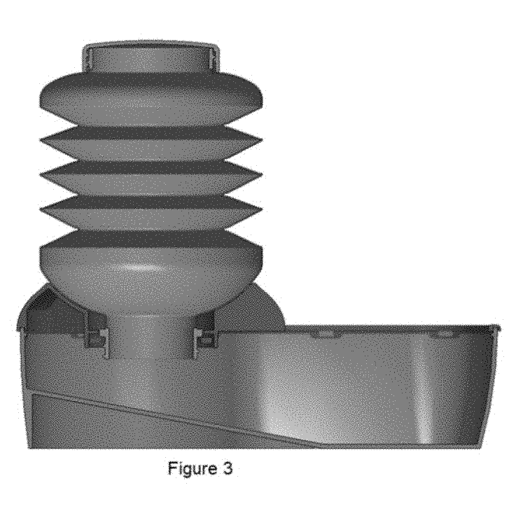

FIG. 1 illustrates a perspective view of one exemplary embodiment of a collapsible pet feeder 10 of the present invention. FIG. 2 illustrates an exploded view of the collapsible pet feeder of FIG. 1. As shown, the collapsible pet feeder apparatus for holding pet food or water is preferably comprised of: a collapsible storage compartment 12 adapted to be expanded to an elongated state for storing pet food or water, the storage compartment having a top portion 14, middle portion 16 and bottom portion 18 and an opening 20 in the top portion and an opening 22 in the bottom portion; and a bowl portion 24 positioned underneath the opening in the bottom portion of the collapsible storage compartment for holding pet food or water and wherein the bowl portion extends away from a side of the collapsible storage compartment.

In the preferred embodiment, the collapsible storage compartment is cylindrical in shape with the opening in the bottom portion having a smaller diameter than the middle portion. In the preferred embodiment, the present invention is comprised of a cap 26 for capping the opening in the top portion, and where the opening in the top portion is adapted to accept food or water. The collapsible storage compartment is adapted to be collapsed for easier storage or transport.

In the preferred embodiment, the present invention is comprised of an adapter portion 28 positioned between the bottom portion of the collapsible storage compartment and the bowl portion and wherein the adapter portion is removably latched to the bowl portion and wherein the adapter portion has an opening 30 for accepting the collapsible storage compartment and holding it into place. FIG. 3 illustrates a cross-section side view of the collapsible pet feeder of FIG. 1.

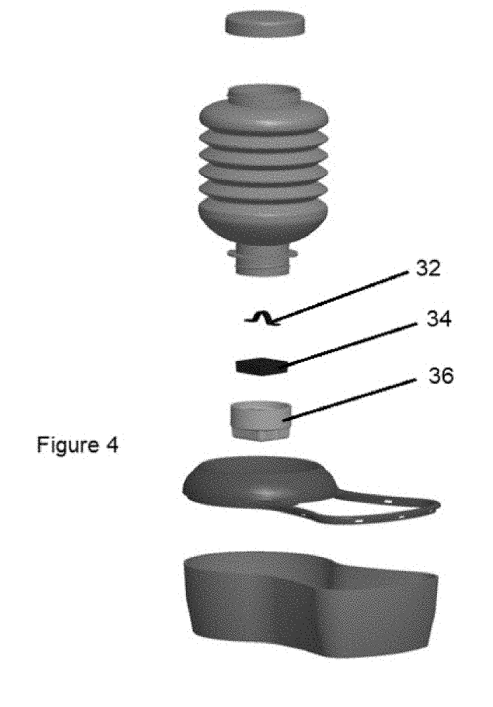

FIG. 4 illustrates an exploded view of a water version of the collapsible pet feeder of the present invention. In the preferred embodiment, the water version has the same components as the food version of FIGS. 2 and 3, with the additional components of a handle 32, filter 34, and water cap 36. The water filter placed at the bottom of the collapsible storage compartment filters the water before it enters the bowl. In the preferred embodiment, the water cap screws onto the bottom portion of the collapsible storage compartment.

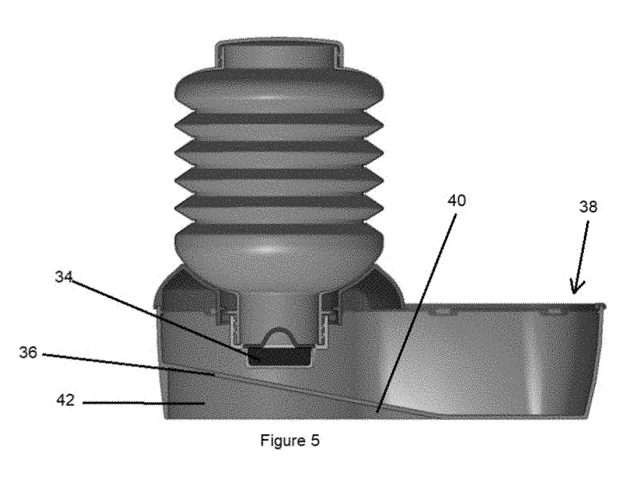

FIG. 5 illustrates a cross-section side view of the water version of the collapsible pet feeder of the present invention. As illustrated, both the food and water versions preferably have an angled slide portion 36 positioned underneath the opening in the bottom portion of the collapsible storage compartment for facilitating the movement of pet food or water from the collapsible storage compartment to a distal end 38 of the bowl portion. In the preferred embodiment, the slide portion is at an 5-20 degree angle. FIG. 5 illustrates the slide portion at an 11 degree angle 40.

In one embodiment, a cut-out or hollow portion 42 is placed underneath the angled slide portion. In another embodiment, the hollow portion can be made in an arched shape. The opening in the bottom portion of the collapsible storage compartment is positioned so that pet food (or water for the water version) stored in the collapsible storage compartment is blocked from going into the bowl portion when the bowl portion is full of pet food. In other words, as the food moves from the storage compartment into the bowl, the food hits the slide portion and rolls into the bowl and moves toward the distal end of the bowl. The bowl fills up with food until eventually the food gets backed up on the slide portion. Eventually, the opening in the bottom portion of the storage compartment will become blocked preventing the food from the storage compartment from entering the bowl. As food is removed from the bowl portion (e.g., as the pet eats the food), the bowl empties, allowing the opening in the bottom of the storage compartment to become unblocked which allows more food to drop into the bowl. In practical effect, gravity provides force to move the food or water from the storage compartment into the bowl, when the bowl is not full.

In the preferred embodiment, the top of the bowl portion is positioned above the bottom portion when the collapsible storage compartment is attached to the bowl portion.

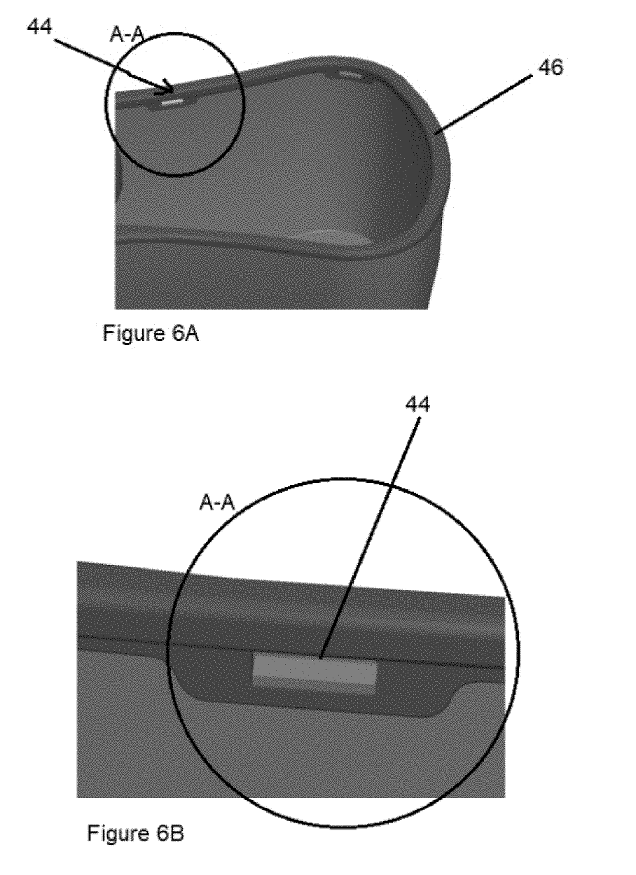

FIG. 6A illustrates a close-up view of the latch portion 44 of the present invention. FIG. 6B illustrates a close-up view of FIG. 6A. In the embodiment of FIGS. 6A and 6B, the adapter portion has a rim portion 46 that matches the shape of the bowl portion. The rim portion contains a plurality of openings for engaging matching latch portions on the bowl that latch the adapter portion to the bowl portion.

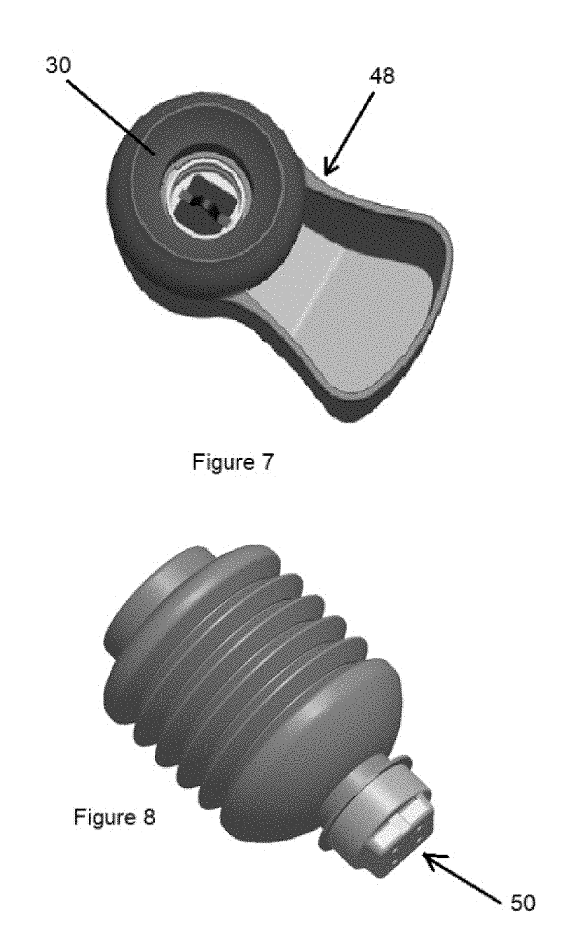

FIG. 7 a top view of the water version of the collapsible pet feeder of the present invention with the collapsible storage compartment removed. As shown the filter is shown with an attached handle for facilitating removal of the filter. As illustrated, in this embodiment, the distal end of the bowl portion is wider than a middle portion 48 of the bowl portion.

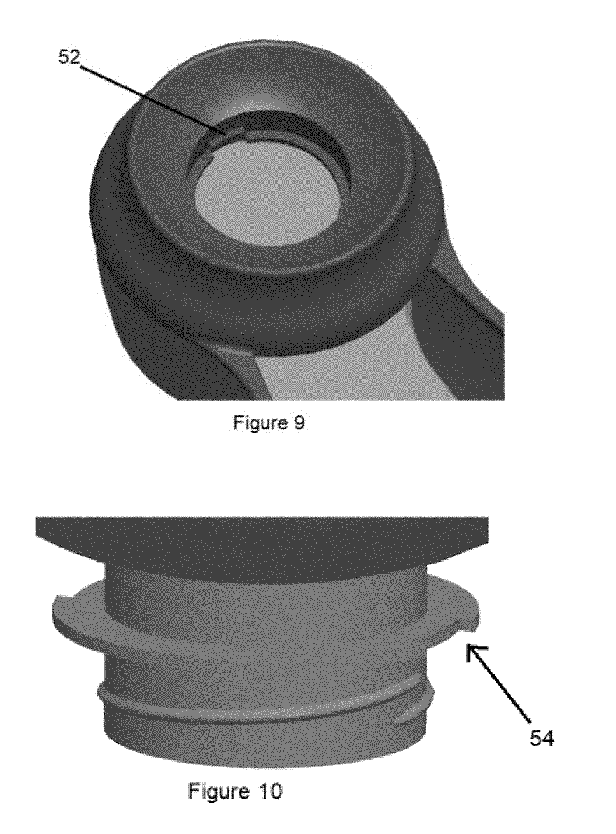

FIG. 8 illustrates one embodiment of the collapsible storage compartment with a water cap. As illustrated, the water cap has a plurality of openings 50 on the bottom of the water cap that allow water to move from the collapsible storage compartment to the bowl portion. Like the food version, the water moving into the bowl portion will be blocked when the bowl portion becomes full of water.

FIG. 9 illustrates one embodiment of the adapter portion of the present invention. In this embodiment, the adapter portion is adapted with a twist lock retainer portion 52. The bottom portion of the collapsible storage compartment is adapted with a matching lock portion 54 that locks the storage compartment to the adapter portion when twisting the storage compartment to the adapter portion. FIG. 10 illustrates one embodiment of the bottom portion of the collapsible storage compartment of the present invention showing one embodiment of the lock portion 54.

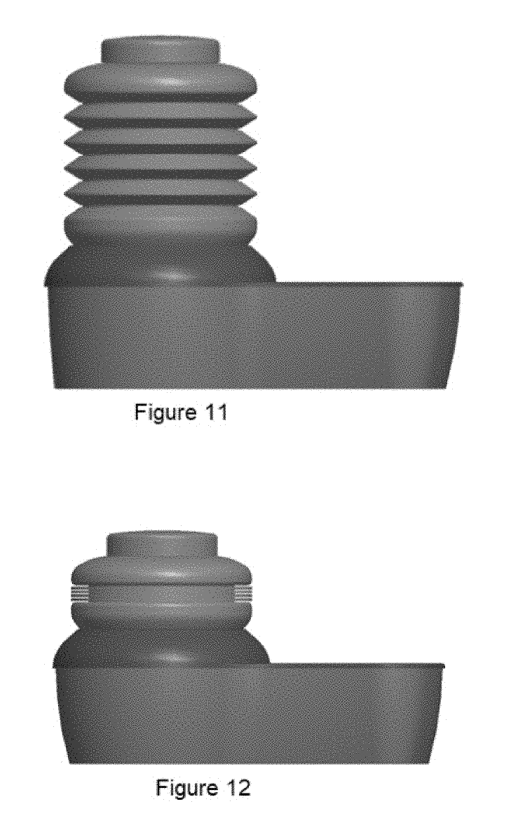

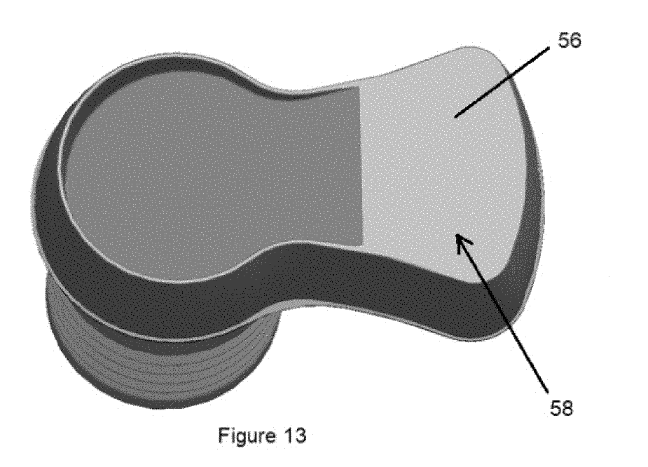

FIG. 11 illustrates a side view of the water version of the collapsible pet feeder of the present invention with the collapsible storage container in an expanded state. FIG. 12 illustrates a side view of the water version of the collapsible pet feeder of the present invention with the collapsible storage container in a collapsed state. FIG. 13 illustrates one embodiment of the bottom 56 of a distal portion of the bowl of the present invention. As shown in FIG. 13, the distal end of the bottom of the bowl portion is adapted to provide a friction grip on the ground. In one embodiment, the bottom of the distal end has a rubber portion 58 for providing a friction grip on the ground.

While certain embodiments of the present invention are described in detail above, the scope of the invention is not to be considered limited by such disclosure, and modifications are possible without departing from the spirit of the invention as evidenced by the following claims:

What is claimed is:

1. A collapsible pet feeder apparatus for holding pet food or water, comprising:
a collapsible storage compartment adapted to be expanded to an elongated state for storing pet food or water, the storage compartment having a top portion, middle portion and bottom portion and an opening in the top portion and an opening in the bottom portion;
a bowl portion positioned underneath the opening in the bottom portion of the collapsible storage compartment for holding pet food or water and wherein the bowl portion extends away from a side of the collapsible storage compartment; and
an angled slide portion positioned underneath the opening in the bottom portion of the collapsible storage compartment for facilitating the movement of pet food or water from the collapsible storage compartment to a distal end of the bowl portion.

2. The apparatus of claim 1, wherein the distal end of the bowl portion is wider than a middle portion of the bowl portion.

3. The apparatus of claim 1, further comprising:
an arched-shaped, cut-out portion underneath the angled slide portion.

4. The apparatus of claim 1, wherein the angled slide portion is at an 11 degree angle.

5. The apparatus of claim 1, wherein the opening in the bottom portion of the collapsible storage compartment is positioned so that pet food in the collapsible storage compartment is blocked from going into the bowl portion when the bowl portion is full of pet food.

6. The apparatus of claim 1, wherein the top of the bowl portion is positioned above the bottom portion when the collapsible storage compartment is attached to the bowl portion.

7. The apparatus of claim 1, wherein the collapsible storage compartment is cylindrical in shape.

8. The apparatus of claim 1, wherein the opening in the bottom portion has a smaller diameter than the middle portion.

9. The apparatus of claim 1, further comprising:
a cap for capping the opening in the top portion, and wherein the opening in the top portion is adapted to accept food or water.

10. The apparatus of claim 1, wherein the collapsible storage compartment is adapted to be collapsed for easier storage or transport.

11. The apparatus of claim 1, wherein the slide portion is at an angle between 5 and 20 degrees.

12. The apparatus of claim 1, wherein the bowl portion has a bottom and wherein the distal end of the bottom of the bowl portion is adapted to provide a friction grip on the ground.

13. The apparatus of claim 12, wherein the bottom of the distal end has a rubber portion for providing a friction grip on the ground.

14. The apparatus of claim 1, further comprising:
an adapter portion positioned between the bottom portion of the collapsible storage compartment and the bowl portion and wherein the adapter portion is removably latched to the bowl portion and wherein the adapter portion has an opening for accepting the collapsible storage compartment and holding it into place.

15. The apparatus of claim 14, wherein the adapter portion and collapsible storage compartment are configured so that the collapsible storage compartment locks into place on the adapter portion when twisted together.

16. The apparatus of claim 1, further comprising:
a water cap positioned at the opening in the bottom portion of the collapsible storage compartment, the water cap having a plurality of holes for allowing water to move from the collapsible storage compartment into the bowl portion.

17. The apparatus of claim 16, further comprising:
a filter placed over the plurality of holes in the water cap for filtering water; and
a handle attached to the filter for facilitating removal of the filter.

18. A collapsible pet feeder apparatus for holding pet food, comprising:
a collapsible storage compartment adapted to be expanded to an elongated state for storing pet food, the storage compartment having a top portion, middle portion and bottom portion and an opening in the top portion and an opening in the bottom portion;
a bowl portion positioned underneath the opening in the bottom portion of the collapsible storage compartment for holding pet food and wherein the bowl portion extends away from a side of the collapsible storage compartment; and
an angled slide portion positioned underneath the opening in the bottom portion of the collapsible storage compartment for facilitating the movement of pet food from the collapsible storage compartment to a distal end of the bowl portion.

19. The apparatus of claim 18, wherein the distal end of the bowl portion is wider than a middle portion of the bowl portion.

20. The apparatus of claim 18, further comprising:
an arched-shaped, cut-out portion underneath the angled slide portion.

21. The apparatus of claim 18, wherein the angled slide portion is at an 11 degree angle.

22. The apparatus of claim 18, wherein the opening in the bottom portion of the collapsible storage compartment is positioned so that pet food in the collapsible storage compartment is blocked from going into the bowl portion when the bowl portion is full of pet food.

23. The apparatus of claim 18, further comprising:
an adapter portion positioned between the bottom portion of the collapsible storage compartment and the bowl portion and wherein the adapter portion is removably latched to the bowl portion and wherein the adapter portion has an opening for accepting the collapsible storage compartment and holding it into place.

24. A collapsible pet feeder apparatus for holding pet food or water, comprising:
a collapsible storage compartment adapted to be expanded to an elongated state for storing pet food or water, the storage compartment having a top portion, middle portion and bottom portion and an opening in the top portion and an opening in the bottom portion;
a bowl portion positioned underneath the opening in the bottom portion of the collapsible storage compartment for holding pet food or water and wherein the bowl portion extends away from a side of the collapsible storage compartment;
an angled slide portion positioned underneath the opening in the bottom portion of the collapsible storage compartment for facilitating the movement of pet food or water from the collapsible storage compartment to a distal end of the bowl portion; and
an adapter portion positioned between the bottom portion of the collapsible storage compartment and the bowl portion and wherein the adapter portion is removably latched to the bowl portion and wherein the adapter portion has an opening for accepting the collapsible storage compartment and holding it into place.

25. An apparatus according to claim 24, wherein the opening in the bottom portion of the collapsible storage compartment is positioned so that pet food in the collapsible storage compartment is blocked from going into the bowl portion when the bowl portion is full of pet food.
